(19) United States
(12) Patent Application Publication
(10) Pub. No.: US 2009/0206070 A1
(43) Pub. Date: Aug. 20, 2009

(54) Electronic Control For Range

(76) Inventors: Matthew Ortner, Greenwood, MS (US); Brent Bailey, Greenwood, MS (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/369,098

(22) Filed: Feb. 11, 2009

Related U.S. Application Data
(63) Continuation-in-part of application No. 12/115,202, filed on May 5, 2008.
(60) Provisional application No. 61/027,610, filed on Feb. 11, 2008.
(60) Provisional application No. 60/927,836, filed on May 4, 2007.

(51) Int. Cl. F24C 7/08; G05D 23/19

(52) U.S. Cl. 219/398; 219/506; 116/307; 116/316

(57) ABSTRACT

An electronic control for a range including a control panel with a display surface, at least one control, and a display module. The display surface is substantially reflective, but allows transmission of light from an inside to an outside of the range. The display module includes an augmentation element to illuminate a display and transmit the illuminated display through the display surface. The display module can be disposed at an angle to the display surface. The display surface mimicking the surrounding material to allow the display surface to blend into the surface of the display module, with the surface being illuminated through designed to be camouflaged into the background. The at least one control can be a knob, a button, or a series of buttons or knobs. The display can provide function status of an item in the range.

### PRIORITY APPLICATION

This application claims the benefit of U.S. Provisional Application No. 61/027,610, filed Feb. 11, 2008, which is hereby incorporated by reference in its entirety.

### RELATED APPLICATION

The present application is a continuation-in-part of U.S. application Ser. No. 12/115,202, filed May 5, 2008, which claims the benefit of U.S. Provisional Application No. 60/927,836, filed May 4, 2007, both of which are hereby incorporated by reference in their entirety with the present application claiming the benefit thereof.

### SUMMARY

Several designs for an electronic control for a range are disclosed. The electronic control can include numerous buttons, controls, or displays, generally that enable individual control of each burner on the range top or an individual oven(s).

A first embodiment comprises an electronic oven or range control that is moveable from a fully retracted stowed position to an extended, operative position. Once a user initiates an operational procedure, such as by turning a knob, dial, or button, the electronic control can be extended from its retracted position, where it can be generally hidden from view and engagement, such as below the landing ledge of the range top, to its fully extended operative position, or any intermediate position therebetween. Optionally, the electronic control can be manually or physically pulled or pivoted by the user and can be locked into position, such as in the fully extended position. Once the user finishes using the range and/or the electronic control, the electronic control can be manually or automatically retracted from its extended position to its retracted position, with such extension/retraction occurring by a lateral or longitudinal movement, motion, rotation, combination of lateral, longitudinal and/or rotation, or otherwise.

An example method of operating an electronic control for a range according to the first embodiment can include: providing an electronic control, the electronic control being generally disposed in a retracted position that substantially hides the electronic control from view; initiating a control to cause the electronic control to be moved from the retracted position to an extended position to bring the electronic control into view; operating the range with the electronic control in the extended position; and engaging the control to cause the electronic control to be retracted from the extended position to the retracted position once operating the range is complete. The retracted position can hide the electronic control beneath a landing ledge. Further, the method can include locking the electronic control in the extended position, or locking the electronic control in the retracted position.

A range with a retractable electronic control capable of performing the above method can include: an oven with an oven cavity closed by a door; a range top with burners; wherein the electronic control can include a body moveably mounted adjacent the range top and can have a series of low-profile controls arranged along the body; the electronic control can be generally disposed in a retracted position, but extendable to an operative position by initiation of a user input; and wherein operation of the oven and the range top can be controlled by the electronic control. The user input can be turning a dial or knob, or pushing a button. Further, the retracted position can hide the electronic control beneath a landing ledge of the range, a lock can be provided to lock the electronic control in the extended position, or a lock can be provided to lock the electronic control in the retracted position.

Another range with a retractable electronic control capable of performing the above method can include: an oven; a range top; a control module including interactive controls for controlling functions of the range; the control module being movable between a retracted position wherein the control module is hidden out of sight and an extended position wherein the control module is visible and accessible to a user. A landing ledge can be included and, in the retracted position, the control module can be disposed beneath the landing ledge. The range can further include at least one additional control and that can be moved between the retracted and extended positions in response to activation of the additional control. Further, the control module can be moved from the retracted position to the extended position manually by a user.

In a second embodiment, the electronic control is disposed directly on the landing ledge of the oven or range. The electronic control of this embodiment can be disposed in various positions along the landing ledge and can be positioned in different locations therealong, as well as providing for the use of multiple electronic controls, depending on the size and/or configuration of the range or oven.

In a third embodiment, the electronic control is disposed on a rail, generally in a position proximate, and in front of, the landing ledge, although the electronic control could also be moveably disposed along the rail. Fourth through eighth embodiments can provide the electronic control on a control panel portion of the range, and can include various controls, such as knobs, buttons, touch controls, wheels, and/or slides. All controls can be operated via manual or automatic operation.

In ninth and tenth embodiments, an electronic control for a range that includes a control panel with a display surface, at least one control, and a display module is disclosed. The display surface is substantially reflective, but allows transmission of light from an inside to an outside of the range allows one-way transmission of a display only when the appliance controls are activated. The display module includes an augmentation element to illuminate a display and transmit the illuminated display through the display surface. The augmentation element can be a backlight or reflector. The display module can be disposed at an angle to the display surface to allow easier viewing. The angle, for example, can be approximately 45 degrees, or can be approximately 30 degrees. The display surface is formed to mimic the surrounding material, i.e. the surface being illuminated through is designed to be camouflaged into the background. Generally, the display surface can be formed of one-way mirrored glass, one-way transparent glass, or one-way transparent plastic. For example, if the display module is formed of stainless steel and the display surface is formed of mirrored glass, the display surface is designed to have the appearance of stainless steel with the mirrored glass blending into the surface of the display module. The control can be a knob, a button, or a series of buttons or knobs. The display can provide function status of an item in the range (such as temperature, clock, function, or other display option). Alternatively, two display surfaces disposed on both sides of a control knob with buttons disposed between each display surface and the knob can be provided.

In an eleventh embodiment, a range with an electronic control that includes an oven cavity closed on one side by an oven door and a heating element controlled by the electronic control is disclosed. The electronic control includes a control panel with a display surface, at least one control, and a display module. The display surface is substantially reflective, but allows transmission of light from an inside to an outside of the range. The display module includes an augmentation element to illuminate a display and transmit the illuminated display through the display surface. Additionally, the augmentation element can be a backlight or reflector. The display module can be disposed at an angle to the display surface. The angle, for example, can be approximately 45 degrees, or can be approximately 30 degrees. The display surface can be one-way mirrored glass, one-way transparent glass, or one-way transparent plastic. The at least one control can be a knob, a button, or a series of buttons or knobs. The display can provide function status of an item in the range. Further, the invention can provide two display surfaces disposed on both sides of a control knob with buttons disposed between each display surface and the knob. The range can also include a range top controlled by the electronic control.

The foregoing and other features, aspects, and advantages of the invention will become more apparent upon review of the detailed description of the embodiments set forth below when taken in conjunction with the accompanying drawing figures, which are briefly described as follows.

### BRIEF DESCRIPTION OF THE DRAWINGS

FIG. 1 shows a first embodiment of a range with an electronic control in a fully retracted position.

FIG. 2 shows the electronic control being extended from beneath the landing ledge proximate the top of the range.

FIG. 3 shows the electronic control in its fully extended position.

FIG. 4 shows a side view of the range shown in FIG. 1 with the electronic control in the fully retracted position.

FIG. 5 is a side view illustrating the extension of the electronic control from its fully retracted position.

FIG. 6 shows a second embodiment of the electronic control disposed directly on a range's landing ledge.

FIG. 7 shows an exploded view of the electronic control on the landing ledge of a range.

FIG. 8 shows a third embodiment with the electronic control disposed on a rail proximate the landing ledge of the range.

FIG. 9 shows an exploded view of the electronic control disposed on the rail according to the third embodiment.

FIG. 10 shows a fourth embodiment of the electronic control disposed in a different rail configuration.

FIG. 11 shows the embodiment of the electronic control of FIG. 10 mounted along the rail of a range.

FIG. 12 shows an exploded view of the electronic control on the rail according to the embodiment of FIGS. 10-11.

FIGS. 13A and 13B show a fifth embodiment of the electronic control disposed on the landing ledge of a range.

FIG. 14 shows a sixth embodiment with the electronic control disposed on a front panel portion of a range.

FIG. 15 shows a seventh embodiment of an electronic control disposed on a front panel portion of a range.

FIG. 16 shows an eighth embodiment of an electronic control disposed on a front panel portion of a range.

FIG. 17 shows a ninth embodiment of an electronic control.

FIG. 18 shows a close-up view of the ninth embodiment with the display activated.

FIG. 19 shows a cut-away view of the electronic control module of FIG. 17 with the display not activated.

FIG. 20 shows a cut-away view of the electronic control module of FIG. 17 with the display activated.

FIG. 21 shows a tenth embodiment of an electronic control module showing a reflective surface with an internal display not activated.

FIG. 22 shows a perspective view of the electronic control module showing the reflective surface with the display activated.

FIG. 23 shows a front view of the electronic control module showing the reflective surface with the display activated.

FIG. 24 shows an exploded view of the electronic control module and electronic control display according to one aspect of the invention.

### DETAILED DESCRIPTION

For a more complete understanding, reference should be made to the following detailed description and accompanying drawings, wherein like reference numerals, where appropriate, designate corresponding parts throughout the figures.

To facilitate understanding and explanation of the present invention, the description of elements and numerals herein may utilize the terms “upper,” “lower,” “top,” “bottom,” “front,” and “back” to distinguish portions of the electronic control module, or its components. These conventions are included merely for ease of explanation and understanding of the description and should not be construed to be limiting in any manner. Designations such as “upper,” “lower,” etc., also can be “first,” “second,” etc.

According to common practice, the various features of the drawings discussed herein are not necessarily drawn to scale. Dimensions of various features and elements in the drawings may be expanded or reduced to illustrate more clearly the embodiments of the invention. The dimensions of the electronic control module, appliance, control panel, casing, display, and reflective surface can also be modified, for example, to accommodate various appliance dimensions, knob types, button types, touch screen panel control systems, or other accessories.

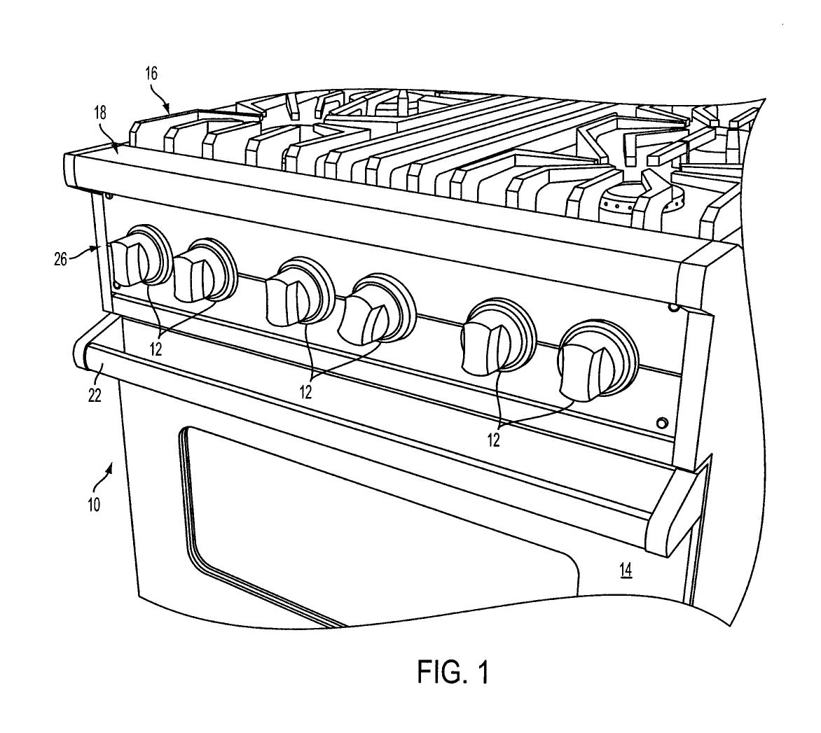

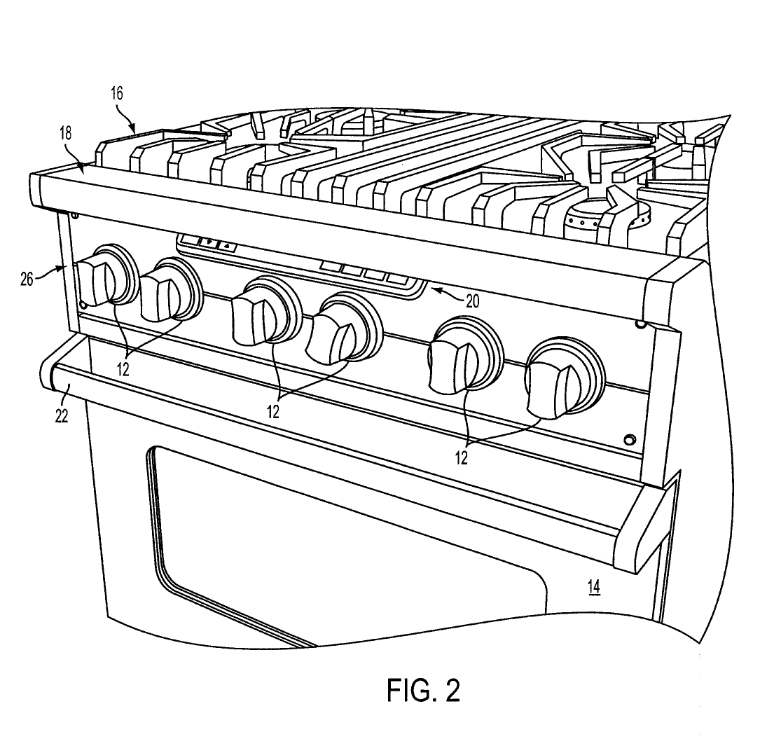

Referring now to the drawings, FIG. 1 shows a first embodiment of a range 10 incorporating an electronic control 20 (visible in FIG. 2) according to the principles of the present disclosure. The range 10 is shown as including at least one control knob 12 capable of initiating control of an oven 14 and/or a range top 16. As shown in the figures, the control knob(s) 12 are disposed in a spaced array beneath a landing ledge 18 for the range, and generally are located on, at, or near a front control panel 26, which generally is provided along an upper front portion of the range. A handle 12 is provided for operation of the door of the oven 14. In this first embodiment shown in FIG. 1, the electronic control, generally indicated at 20 (FIG. 2), is in its initial, fully retracted home or non-operative position (here hidden and out of view), generally retracted under the landing ledge 18.

As illustrated in FIG. 2, when a user elects to utilize the control panel 20 for operation of either the oven 14 or the range top 16, they can initiate extension of the electronic control 20 toward an extended, operative position either automatically, or by manual operation, such as by engaging a switch, etc, or by physically engaging and moving (e.g., by manually pulling and pushing) the electronic control into its operative position. One initiation example is shown in FIG. 2, where extension of the electronic control 20 is initiated automatically by the user turning one or more of the control knobs 12, one of which is shown rotated in FIG. 2. The automatic extension/retraction of the electronic control also can be linked to engagement of one or more specific knobs 12, as needed or desired, to limit its operation/movement. Once this knob 12 is turned, or once some other initiation process, such as the push of a button, turn of a dial, flip of a switch, etc., occurs, the electronic control 20 can automatically begin to be extended from its fully retracted position, as illustrated in FIG. 2.

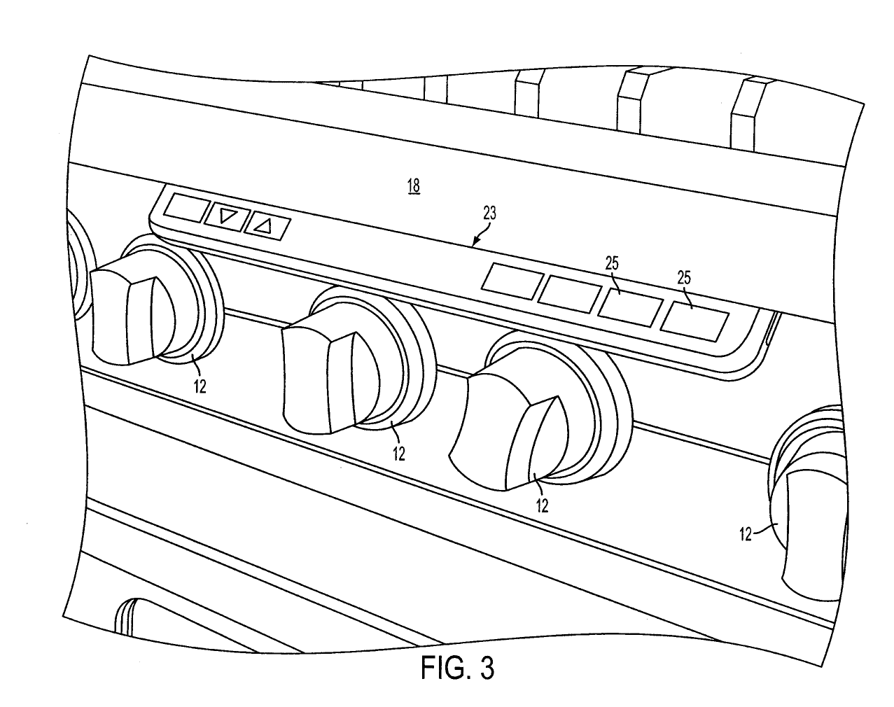

As indicated in FIG. 3, once initiated, the electronic control typically continues to extend from its fully retracted home or non-operative position to its fully extended, operative position, whereupon the electronic control 20 can be utilized to operate the oven 14 and/or the range top 16 via the buttons on the electronic control and/or for reading or displaying the function selected, such as for more precise temperature control, to perform various cooking options, etc. As further indicated in FIG. 3, the electronic control 20 generally can include an elongated body or plate 21, with a substantially flat or low-profile upper surface 23. A series of controls 25, such as buttons, touch pads, etc., are arranged along the upper surface 23 of the body 21, typically having a substantially flat or low-profile configuration to avoid interference with the landing ledge 18 as the electronic control is retracted therebelow. The controls can set/control cook times, start/end times, timers for delayed cooking, and numerous other cooking options for the range.

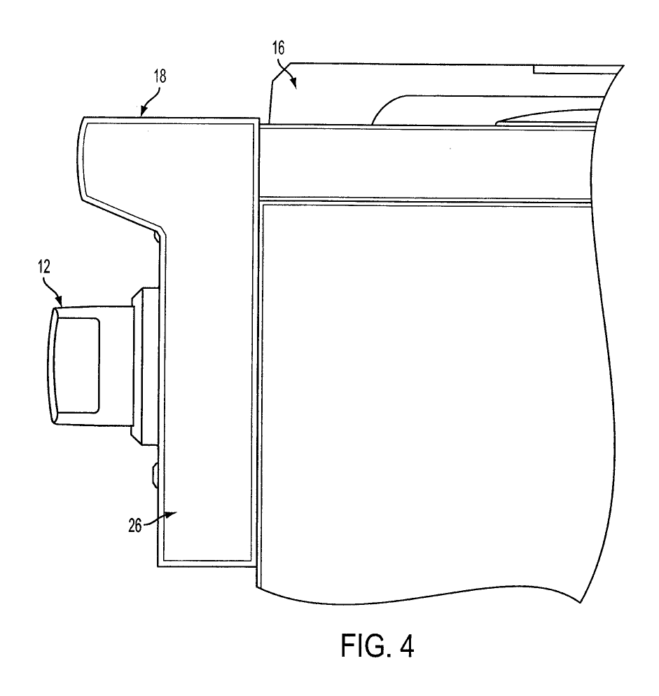

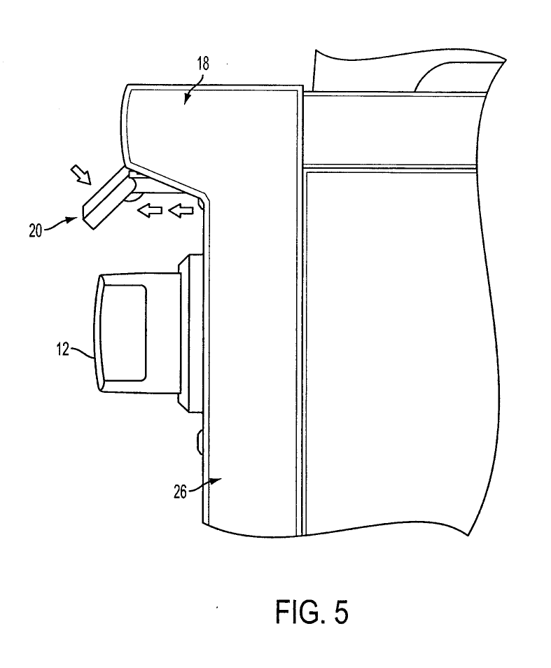

FIG. 4 shows a side view of the range 10 with one of the knobs 12, landing ledge 18, and range top 16. FIG. 4 is analogous to the front view of the range 10 shown in FIG. 1 with the electronic control 20 in a fully retracted, out-of-sight position. One example of the extension of the electronic control 20 is shown in FIG. 5, where, upon initiation, such as by rotation of a knob 12, the electronic control 20 can be linearly extended from its fully retracted position (left pointing arrows) and then hinged or rotated downwardly (right and down pointing arrow) for use. Alternatively, upon initiation, the electronic control 20 can simply be pivoted or rotated outwardly and/or downwardly from its fully retracted position to its fully extended position and locked in place as needed or desired for use. Typically, the movement of the electronic control between its retracted and extended positions will be controlled by an actuator such as a servo or stepper motor or other reversible motor, cylinders, or other actuators. Other alternate extension/retraction variations including physical or manual manipulation by the user, i.e., the user pulling and/or pushing the electronic control away from and toward the landing ledge) also can be utilized within the scope of the present disclosure.

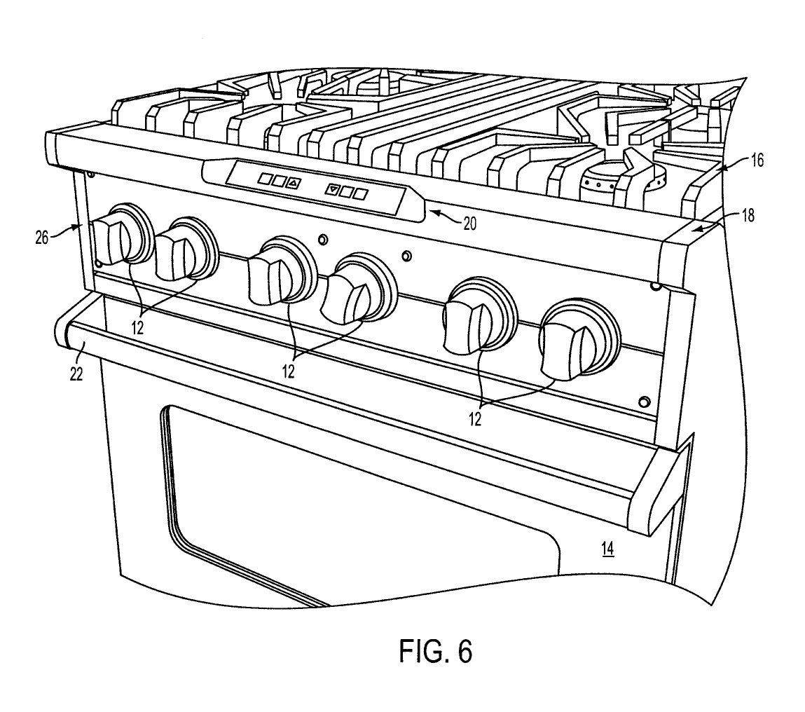

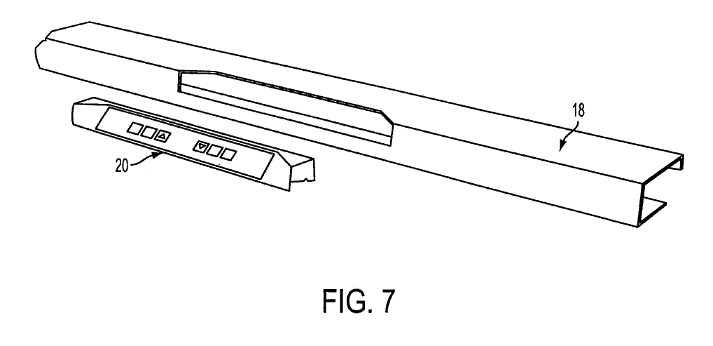

A second embodiment of the electronic control is shown in FIGS. 6-7, whereupon the electronic control panel is disposed directly on a range's landing ledge 18. Analogous to the first embodiment, the second embodiment includes a range 10, control knobs 12, oven 14, range top 16, landing ledge 18, electronic control 20, and handle 22. Although the electronic control 20 is shown disposed in a middle portion of the landing ledge 18, the electronic control 20 can be disposed anywhere along the landing ledge, and the invention is not limited by the size or configuration or placement of the electronic control 20 shown in FIG. 6, and/or the size or configuration of the range on which it is mounted or used. FIG. 7 shows an exploded view of the electronic control fitting on/in the landing ledge according to the second embodiment.

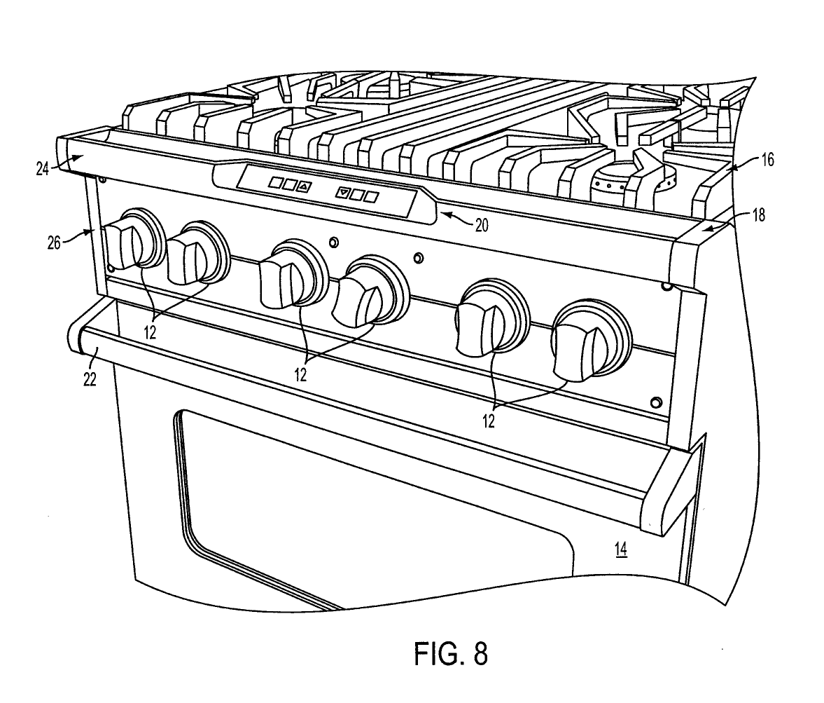

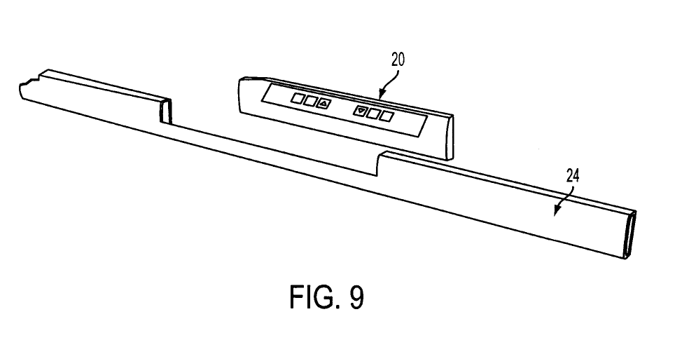

FIGS. 8 and 9 show a third embodiment with the electronic control disposed along a rail 24 in front of the landing ledge 18 of the range 10. FIG. 9 shows an exploded view of the electronic control 20 on the rail 24 according to this third embodiment.

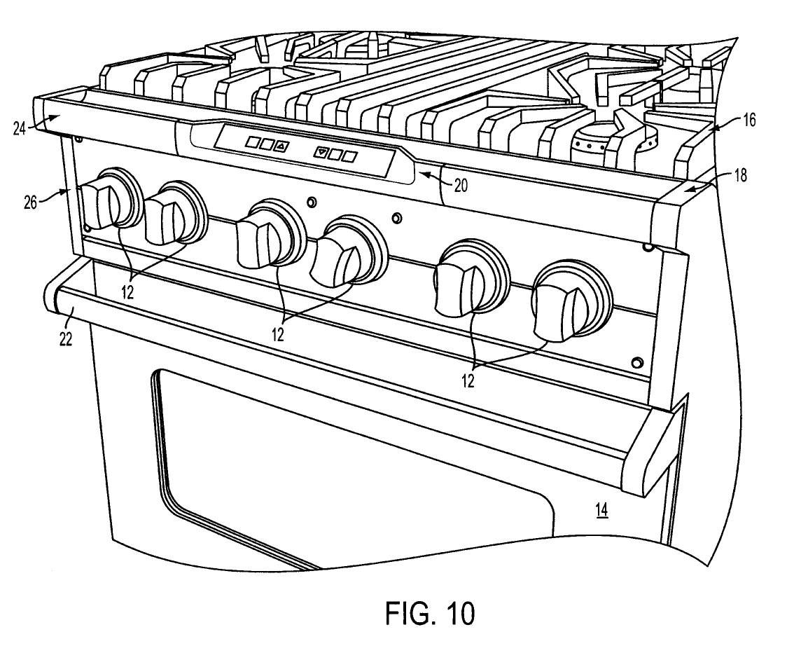

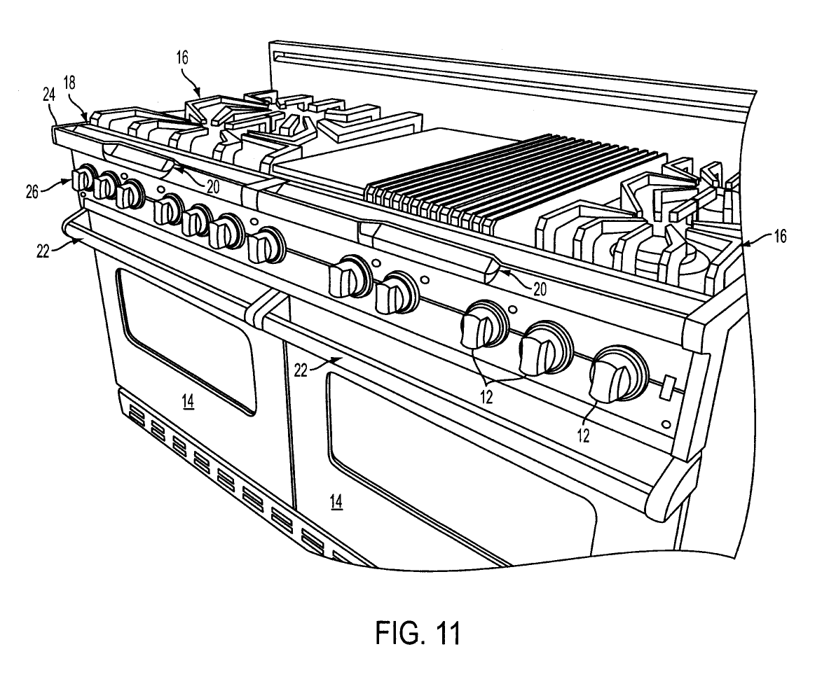

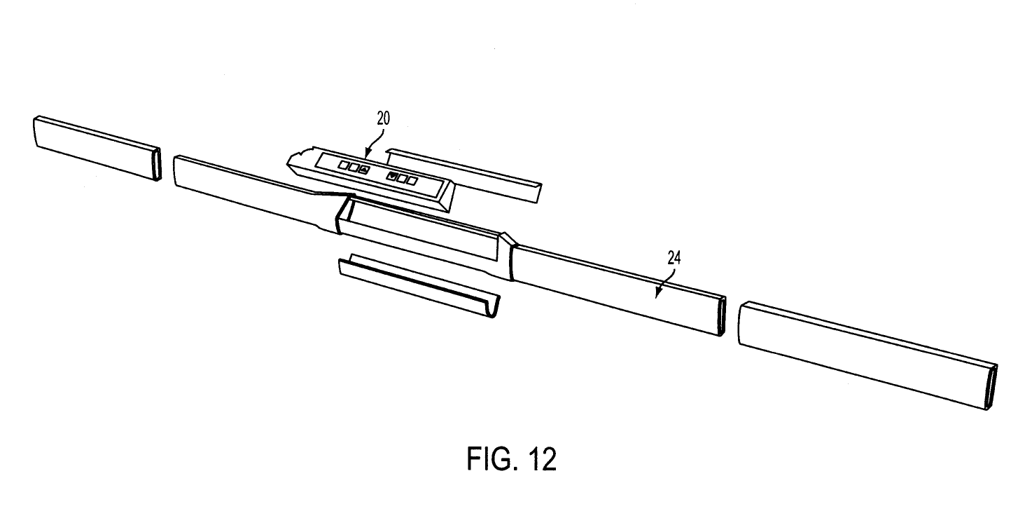

FIG. 10 shows yet another embodiment of the electronic control 20, here shown as disposed in or along a rail of a different configuration than that shown in FIGS. 8-9. The rail configuration shown in FIG. 10 includes an electronic control 20 that comprises a larger or enhanced segment of the rail 24, and which, in this embodiment, for exemplary purposes only, is shown on a typical size range, such as a 30-inch range, although other size ranges also can be used, including similar rail configurations to that shown in FIG. 10. As another example, a 48-inch range can be provided with one or more sets of electronic controls, which electronic controls 20 can be offset. FIG. 11 similarly shows the fourth embodiment of the electronic control having a similar rail configuration to that shown in FIG. 10, on a different, larger range, here shown, for example purposes only, as a 60-inch range with two separate sets of electronic controls 20, both arranged/spaced along the rail 24 and which can control separate ovens 14 and/or separate range tops 16. FIG. 12 shows an exploded view of the electronic control on the rail according to the fourth embodiment.

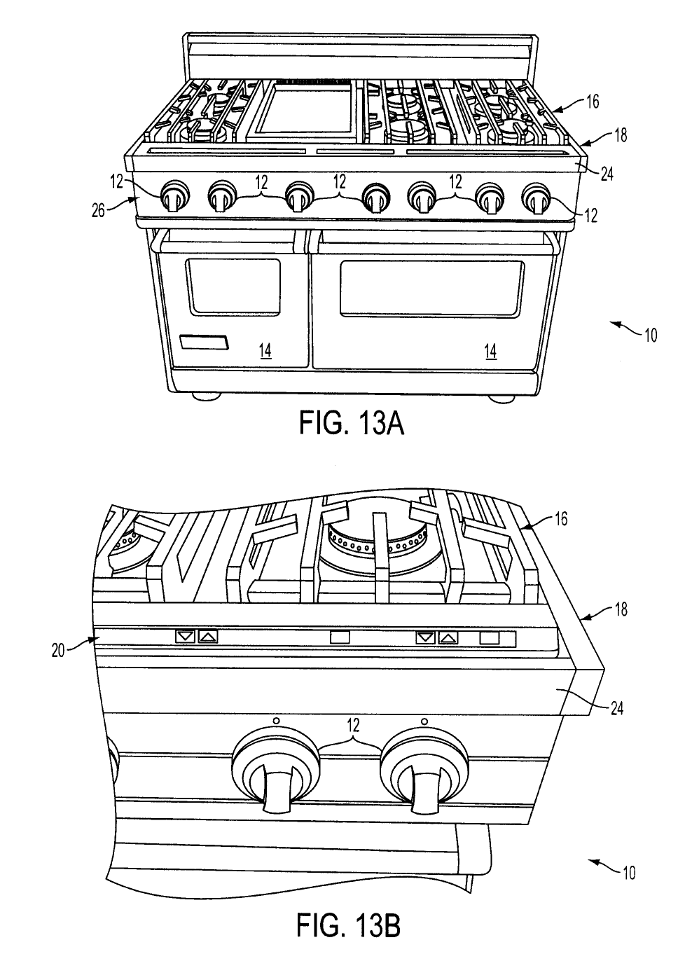

FIGS. 13A and 13B show a fifth embodiment of the electronic control disposed on the landing ledge. In this embodiment, the range is shown with a rail 24 and the electronic control 20 is disposed along the landing ledge 18.

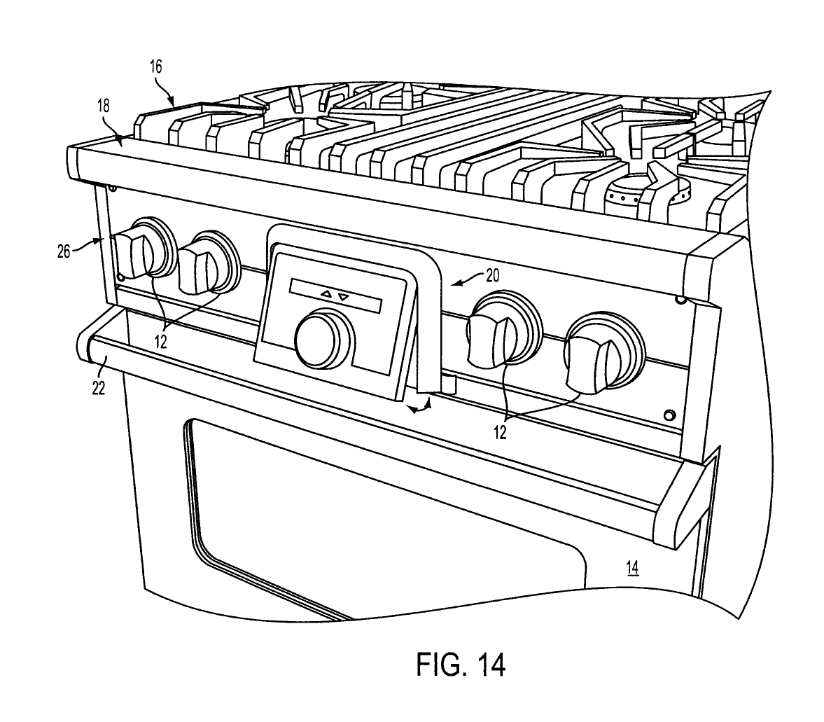

FIG. 14 shows yet a further embodiment with an electronic control 20 disposed on the front panel portion 26 of the range 10. The electronic control 20 of this embodiment further can include a separate control knob, as well as control buttons and displays. Optionally, as indicated, the electronic control 20 of FIG. 14 also can be rotatable upwardly, to allow easier reviewing of the buttons and controls.

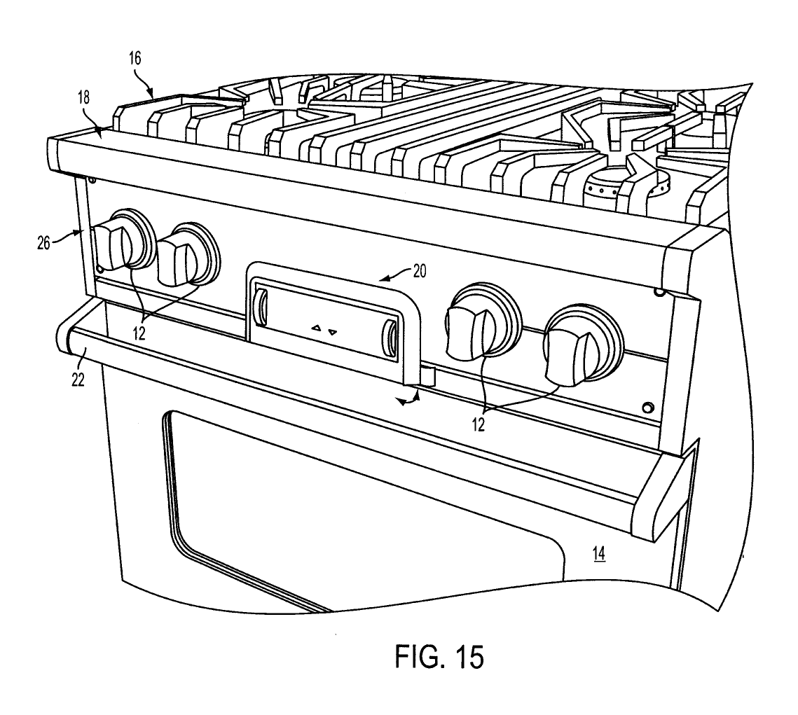

FIG. 15 shows yet another example of a range with the electronic control 20 being disposed on or along the front panel portion 26 of the range 10. The electronic control 20 shown in this additional embodiment includes a dial or dials alongside the display and buttons. Optionally, the electronic control 20 of FIG. 15 also can be rotated upwardly, to allow easier reviewing of the buttons and controls.

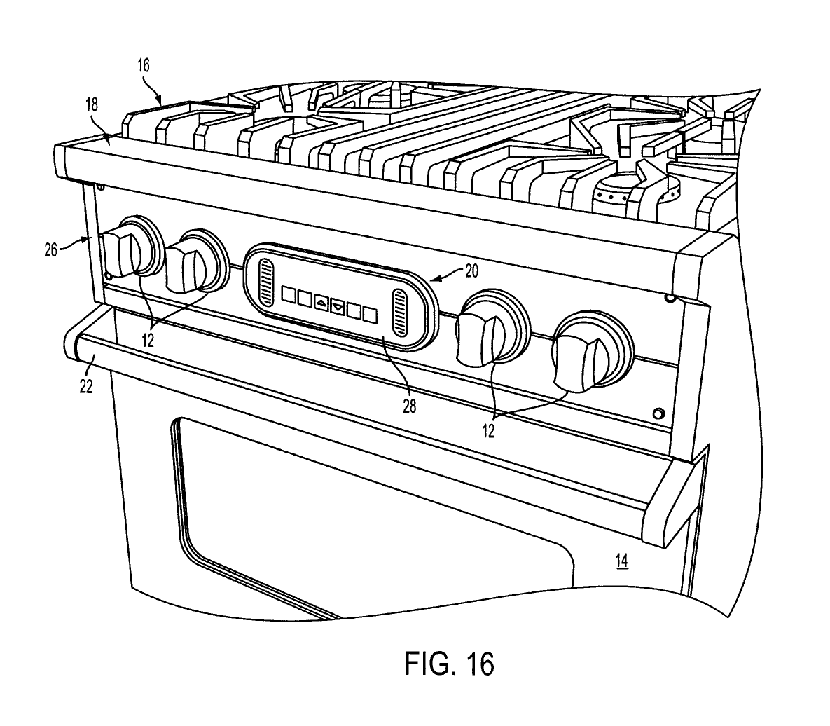

FIG. 16 shows still another embodiment of an electronic control 20 disposed on a control panel 26 of the range 10. Alternatively, the electronic control 20 can also rotate upwardly as needed for viewing. Still further, in this embodiment, the electronic control 20 includes an interactive sliding control 28, which generally is operable based upon touch selection by a user in an upward or downward motion, in a side-to-side motion, or other, similar sliding motion.

Generally, the range detailed herein includes numerous elements that can be formed of numerous materials. For example, while the landing ledge can be formed generally of any metal or metal blend, the landing ledge shown in the figures is an aluminum extrusion. As another example, the electronic control can be formed with a cast metal shell and a brushed material finish. These materials and finishes are exemplary only since the range elements can include and/or be formed of any materials or combinations of materials desired. Further, the handle, rail, and other range elements can be formed surrounding open spaces, such as a hollow tube, to enable receipt of wiring or other optional accessories through the handle tube.

The features of the present disclosure can be interchanged and usable together between embodiments. For example, the electronic control 20 of the first embodiment can include a control analogous to the controls 28 shown in the embodiment of FIG. 16. Also, oven configurations without a rail 24 can optionally be provided with such, and the electronic control 20 can be provided on any surface discussed herein in any embodiment without departing from the spirit and/or scope of the invention.

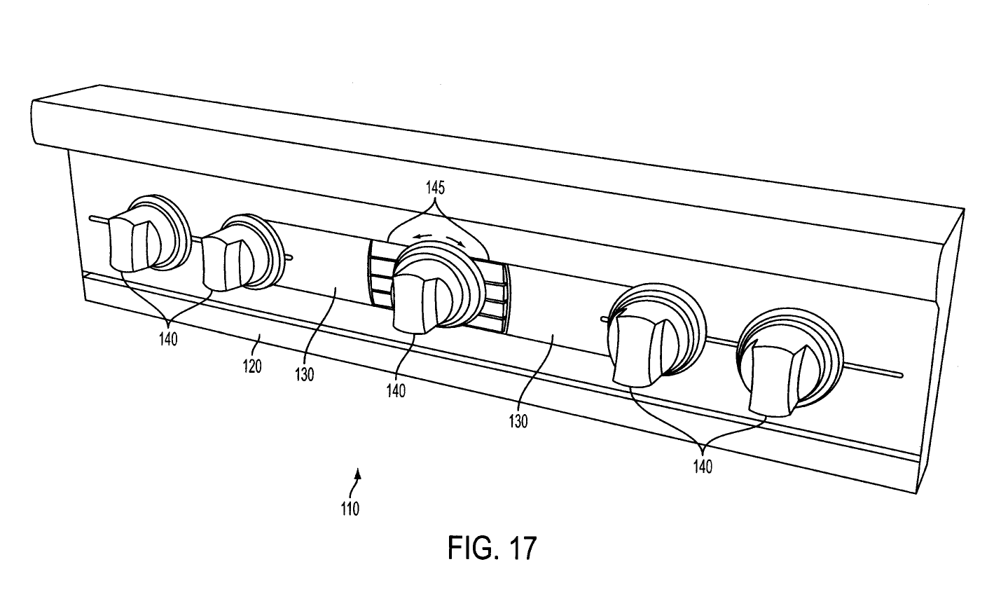

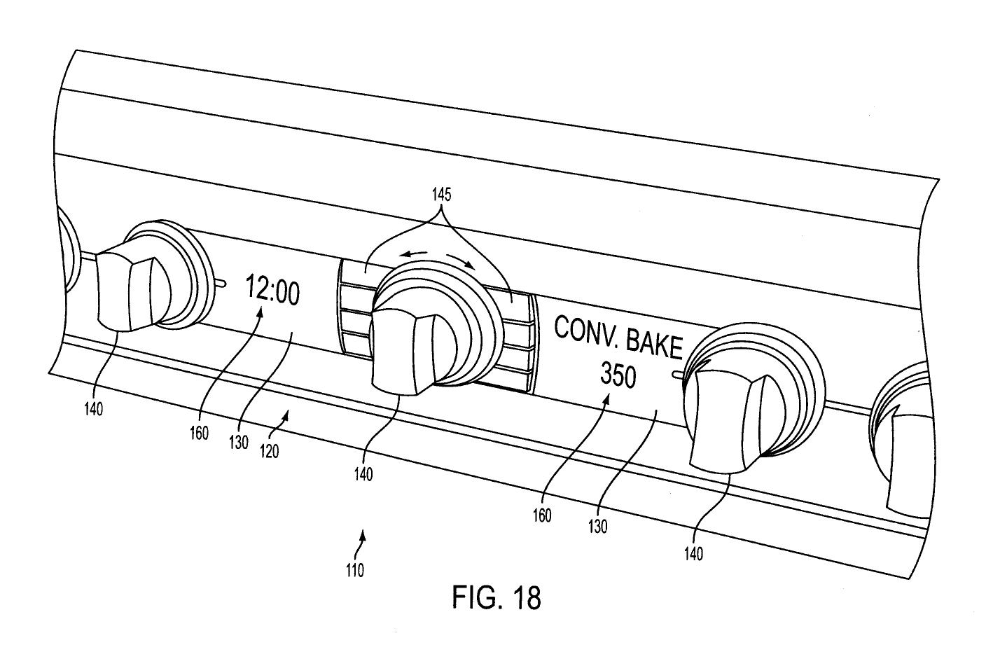

FIGS. 17 and 18 show a ninth embodiment of an electronic control module with a reflective surface covering or disposed over an internal display in an inactive mode. FIG. 17 shows the entire front panel of a range, while FIG. 18 shows a close-up view of a portion of the panel of FIG. 17 with reflective surface. Electronic control module 110 includes a control panel 120, a reflective surface 130, knobs 140 (which can include bezels and/or other components), and buttons 145. Although reflective surface 130 is shown in FIGS. 17 and 18 at a central portion of the control panel 120, the reflective surface can be disposed in any position adjacent the control panel 120. The reflective surface 130 can be one-way mirrored glass, one-way transparent glass, one-way transparent plastic, smoked or tinted glass or plastic, or any one-way material that typically does not allow viewing therethrough of the interior. Generally, transmission of a function, such as a display illuminated in the interior of the appliance through the reflective surface 130. In an alternate embodiment, the control panel 120 can include a touch screen with a substantially planar surface in lieu of knobs, buttons, bezels, or other operation selectors. As shown in FIGS. 17 and 18, the reflective surface 130 acts similar to a mirror when the display 160 has not been activated.

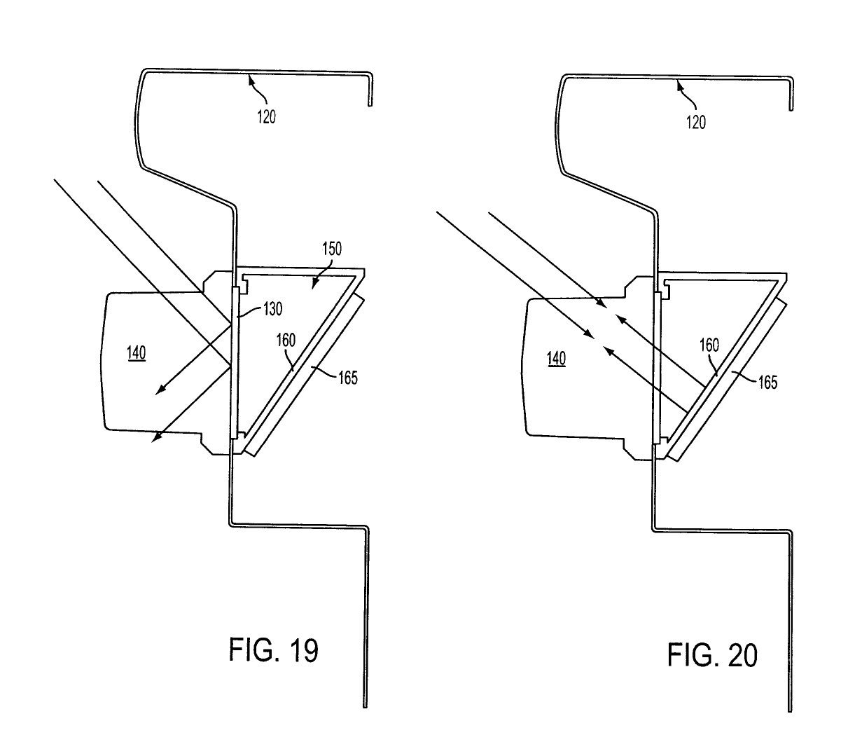

FIG. 19 shows a cut-away view of the electronic control module of FIG. 17 with the display not activated. FIG. 19 shows a control panel 120 with knob 140, reflective surface 130, and display module 150 with display 160 disposed therewithin. Although the display 160 can be disposed at any angle to the reflective surface 130, including at no angle—i.e. parallel reflective surface 130, the display 160 generally is disposed at an angle to allow easier viewing of a selected function through reflective surface 130. As shown in FIG. 19, with display 160 not activated, the reflective surface 130 acts to reflect light (shown in FIG. 19 as two rays reflecting off surface 130).

FIG. 20 shows a cut-away view of the electronic control module of FIG. 17 with the display activated. Once the display 160 has been activated, e.g. by turning or pressing knob 140, pressing button 145, touching a touch screen, rotating or pressing the bezel, or the like, the light from the display transmits through the one-way reflective surface 130 to allow viewing of the function therethrough. Display 160 can be any lamp, display, or module, including, but not limited to, LED (Light-Emitting Diode), VFD (Vacuum Fluorescent Display), and/or LCD (Liquid Crystal Display), or a combination of these or others. Optionally, display module 150 can include a backlight 165, reflector, or other illumination assistant or augmentation element that assists in illuminating, or itself illuminates, display 160.

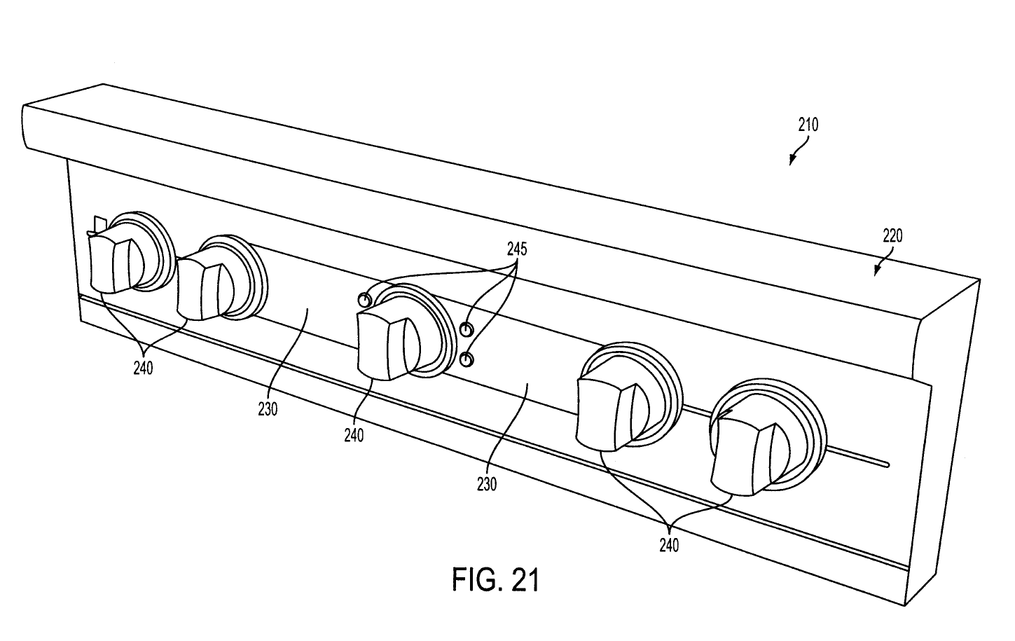

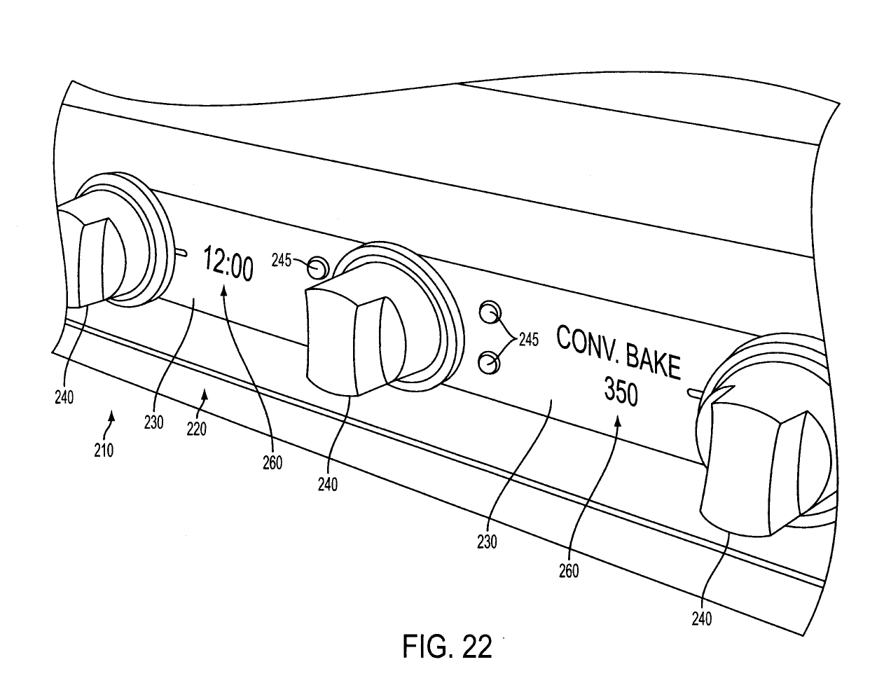

FIG. 21 shows a tenth embodiment of an electronic control module with a reflective surface covering an internal display in an inactive mode. Electronic control module 210 includes a control panel 220, a reflective surface 230, knobs 240 (which can include bezels and/or other components), and buttons 245. Although reflective surface 230 is shown in FIG. 21 at a middle portion of the control panel 220, the reflective surface can be disposed in any position along, atop, beside, or below (or any combination of these) the control panel 220. The reflective surface 230 can be one-way mirrored glass, one-way transparent glass, one-way transparent plastic, smoked or tinted glass or plastic, or any one-way material that typically does not allow viewing therethrough of the interior until a function of the appliance is selected that illuminates a display disposed in the interior. In an alternate embodiment, the control panel 220 can include a touch screen, generally with a substantially planar surface that does not generally include knobs, buttons, bezels, or other operation selectors. As shown in FIG. 21, the reflective surface 230 acts similar to a mirror when the display 260 has not been activated.

FIG. 22 shows a perspective view of the electronic control module showing the reflective surface with the display activated, such as by turning or pressing a knob 240, rotating a bezel, pressing or touching a button 245, or otherwise. When activated, the display 260 illuminates, providing light that penetrates the one-way reflective surface 230. The surface 230 then acts as a readout screen to display the function selected.

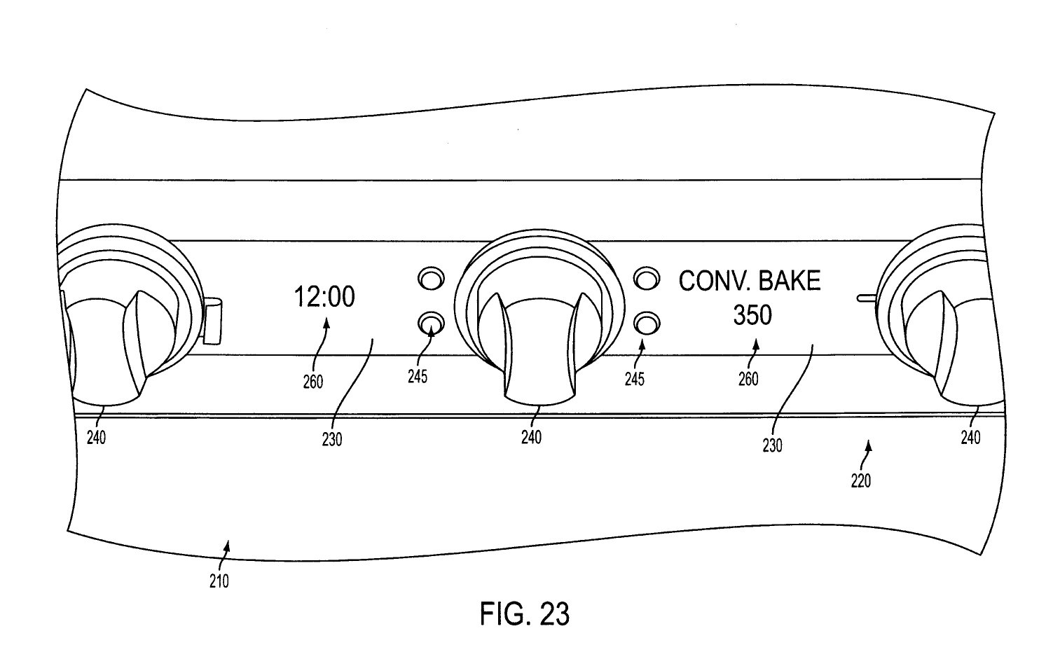

FIG. 23 shows a front view of the electronic control module showing the reflective surface with the display activated. Generally, knobs 240 operate to allow function selection by scrolling through and/or selecting desired appliance functions. Additionally, buttons 245 or the bezel surrounding the knobs 240 can be rotated or pressed to scroll and/or select appliance functions. As shown in FIG. 23, buttons 245 are protruding through the reflective surface 230, but could be disposed planar thereto. Also, the buttons 245 can optionally include identification or operation information (such as “start time,” “clock,” and the like) proximate the buttons 245, with such operation information embedded or etched into the reflective surface, lit from the interior in a manner analogous to display 260, or a combination of these. Further, the identification information can be on the button's surface in lieu of proximate the button as shown in FIG. 23. The button 245 and/or identification information can be illuminated in any color, such as blue, red, green, etc. If the entire, or any part of, the control panel is a touch screen, the operational of identification information can be illuminated responsive to touch instead of by pressing (such as the pressing of a button). Thus, for example, the reflective surface of the control panel can display operational or identification information with an initial touch of the control panel, with subsequent touching of controls displayed through the control panel selecting the desired appliance function.

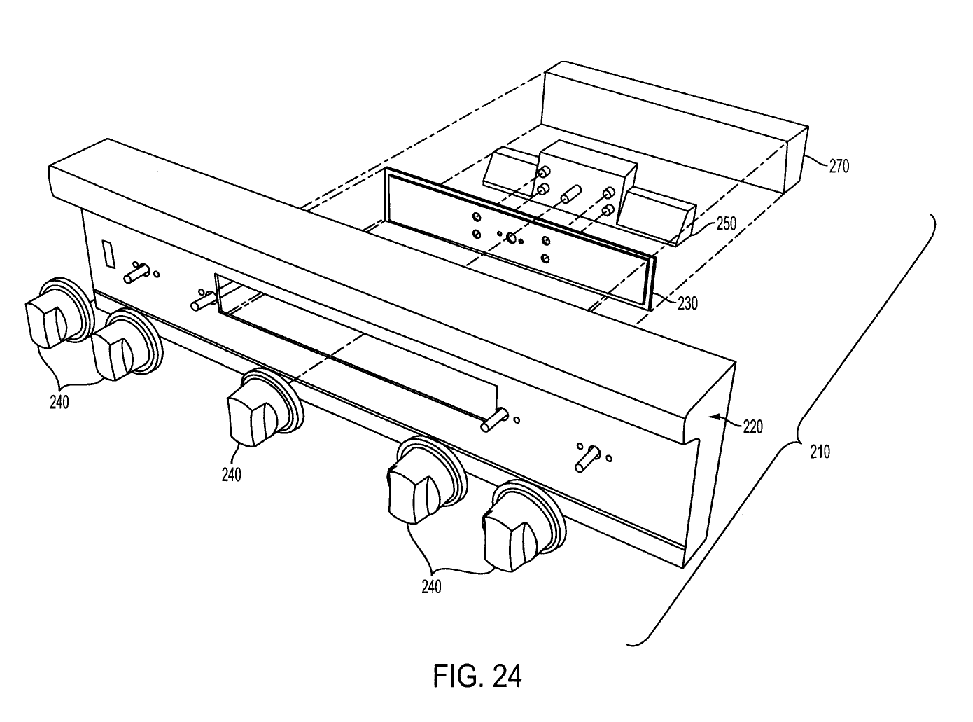

FIG. 24 shows an exploded view of the electronic control module and electronic control display according to one aspect of the invention. The electronic control module 210 generally includes several components and is shown in FIG. 24 with control panel 220, reflective surface 230, knobs 240, display module 250, and casing 270. These components can be attached together in any manner, including friction fit, screws, bolts, etc. These components, or subsets of these components, can be formed as individual pieces, can be cast in combination, or can be manufactured as units that fit together. Casing 270 can include any number of features, but generally is formed as a back box that darkens the area behind the reflective surface 230 to allow the reflective surface 230 to reflect more effectively when the display 260 is not activated.

According to common practice, the various features of the drawings discussed herein are not necessarily shown to scale, dimensions of the various features and elements may be expanded or reduced to illustrate more clearly the embodiments of the invention.

What is claimed:

1. An electronic control for a range, the electronic control comprising:
a control panel including a display surface, at least one control, and a display module;
the display surface being substantially reflective, but allowing transmission of light from an inside to an outside of the range; and,
the display module including an augmentation element to illuminate a display and transmit the illuminated display through the display surface.

2. The electronic control of claim 1 wherein the augmentation element is a backlight or reflector.

3. The electronic control of claim 1 wherein the display module is disposed at an angle to the display surface.

4. The electronic control of claim 3 wherein the angle is approximately 45 degrees.

5. The electronic control of claim 3 wherein the angle is approximately 30 degrees.

6. The electronic control of claim 1 wherein the control panel is formed of a first material and wherein the display surface is formed of a second material; wherein the second material mimics the appearance of the first material.

7. The electronic control of claim 1 wherein the control panel has an outer surface and wherein the display surface has an appearance of the outer surface of the control panel.

8. The electronic control of claim 1 wherein the display surface is one-way mirrored glass, one-way transparent glass, tinted glass, tinted plastic, or one-way transparent plastic.

9. The electronic control of claim 1 wherein the at least one control is a knob, a button, or a series of buttons or knobs.

10. The electronic control of claim 1 wherein the display displays function status of an item in the range.

11. The electronic control of claim 1 including two display surfaces disposed on both sides of a control knob with buttons disposed between each display surface and the knob.

12. A range including an electronic control, the range comprising:
an oven cavity closed on one side by an oven door;
a heating element; the heating element being controlled by the electronic control;
the electronic control including:
a control panel including a display surface, at least one control, and a display module;
the display surface being substantially reflective, but allowing transmission of light from an inside to an outside of the range; and,
the display module including an augmentation element to illuminate a display and transmit the illuminated display through the display surface.

13. The range of claim 12 wherein the augmentation element is a backlight or reflector.

14. The range of claim 12 wherein the display module is disposed at an angle to the display surface.

15. The range of claim 12 wherein the angle is approximately 45 degrees.

16. The range of claim 12 wherein the angle is approximately 30 degrees.

17. The range of claim 12 wherein the display surface is one-way mirrored glass, one-way transparent glass, tinted glass, tinted plastic, or one-way transparent plastic.

18. The range of claim 12 wherein the at least one control is a knob, a button, or a series of buttons or knobs.

19. The range of claim 12 wherein the display provides function status of an item in the range.

20. The range of claim 12 including two display surfaces disposed on both sides of a control knob with buttons disposed between each display surface and the knob.

21. The range of claim 12 wherein the control panel is formed of a first material and wherein the display surface is formed of a second material; wherein the second material mimics the appearance of the first material.

22. The range of claim 12 wherein the control panel has an outer surface and wherein the display surface has an appearance of the outer surface of the control panel.
